(19) United States
(12) Patent Application Publication
(10) Pub. No.: US 2010/0134621 A1
(43) Pub. Date: Jun. 3, 2010

(54) MULTI-AREA MONITORING SYSTEM FROM SINGLE CCTV HAVING A CAMERA QUADRATIC CURVED SURFACE MIRROR STRUCTURE AND IT, AND UNWRAPPING METHOD FOR THE SAME

(75) Inventors: Seong Namkoong, Seongnam-si (KR); Yoon Hyuk Choi, Osan-si (KR); In Jeong Lee, Gwangju (KR); Joon Young Min, Wonju-si (KR); Byung Do Heo, Wonju-si (KR)

Correspondence Address: Jae Y. Park, Kile, Goekjian, Reed & McManus, PLLC, 1200 New Hampshire Ave. NW, Suite 570, Washington, DC, 20036, US

(73) Assignee: KOREA EXPRESSWAY CORPORATION, Seongnam-si, Gyeonggi-do (KR)

(21) Appl. No.: 12/594,518

(22) PCT Filed: Apr. 2, 2008
(86) PCT No.: PCT/KR08/01842

§ 371 Date: Oct. 2, 2009

(30) Foreign Application Priority Data
Apr. 6, 2007 (KR) 10-2007-0034027
Apr. 6, 2007 (KR) 10-2007-0034028
May 2, 2007 (KR) 10-2007-0042614

(51) Int. Cl. H04N 7/18; G02B 5/10; G06K 9/40; B32B 37/00

(52) U.S. Cl. 348/143; 359/838; 382/254; 156/250; 348/E07.085

(57) ABSTRACT

There is provided a camera secondary curved mirror structure which is manufactured by removing a predetermined portion of a circular curved mirror for a camera which is equidistant by a predetermined distance of m/R from each side of a line which passes through the center-point of the circular curved mirror in a vertical direction, to result two curved mirror members; jointing the two curve mirror members together to form a joint line; establishing a cutting line which is perpendicular to the joint line and which is at a predetermined distance n/D from a point where the joint line intersects the circumference of the curved mirror members; and cutting along the cutting line so that a lower portion of the jointed curved mirror members results, to form a curved mirror.

### TECHNICAL FIELD

The present invention relates to a camera secondary curved mirror structure, a CCTV multi-region monitoring system using the same, and a method for correcting a distorted image thereof and, more particularly, to a camera secondary curved mirror structure which is manufactured by removing a predetermined portion of a circular curved mirror for a camera which is equidistant by a predetermined distance of m/R (wherein R is a radius of the circular curved mirror) from each side of a line which passes through the center-point of the circular curved mirror in a vertical direction, to result two curved mirror members; jointing the two curve mirror members together to form a joint line; establishing a cutting line which is perpendicular to the joint line and which is at a predetermined distance n/D (wherein D is a diameter of the curved mirror) from a point where the joint line intersects the circumference of the curved mirror members; and cutting along the cutting line so that a lower portion of the jointed curved mirror members results to form a curved mirror, the camera secondary curved mirror structure which extracts a required region from a curved image picked up by the curved mirror as an curved image in a fan-shape, performs a unwrapping process of the extracted image to be converted into a flat image, and performs a calibration process of the flat image to be restored to the original image, and a CCTV multi-region monitoring system using the same, and a method for correcting a distorted image thereof.

### BACKGROUND ART

Generally, the importance of information protection and security machinery and tools is increasing every day so that a survival strategy of each company as well as each country depends on security at the twenty-first century at which the importance of information increasingly becomes acute. Accordingly, a demand of physical security equipment is greatly increasing and an application technology thereof is also developed.

Specifically, banks, department stores, 24-hour convenience stores, government and public offices install and operate monitoring cameras for the safety of customers. In most of these places, after each independently constituted stationary camera is installed at a place requiring for the camera, an image transferred from the camera is output to a monitor in real-time and simultaneously is recorded in a VCR or DVR.

As a monitoring camera applied in the aforementioned conventional monitoring system has been lately combined with a computer, it has been variously to practical use, performing monitoring which human would conduct with the naked eye. However, since the conventional camera applied for the aforementioned use has a limited viewing angle, a wide-angle lens (for example, fisheye lens) is used for a wider viewing angle for some use. Further, in the field of a robot, research is actively conducted to practically use a rotary type mirror, such as a conical mirror, a spherical mirror, a hyperboloid mirror, or the like, to obtain a wide viewing angle.

Furthermore, in the field of a viewing angle sensor applied to the afore mentioned conventional camera, an all-directional monitoring system has been lately remarkable. In this monitoring system, a camera processes to convert an all-directional image, which is obtained by an optical system and an image pickup device, into an image, such as a panorama image, which is easily viewed by human, by applying software used by a computer.

With reference to FIG. 1, the afore mentioned conventional all-directional monitoring system 70 comprises: an optical system unit 72 using a wide-angle lens or a rotary type mirror 71 (such as a conical mirror, a spherical mirror, a hyperboloid mirror or the like); an image pickup unit 73 converting an optical image obtained by the optical system unit 72 into an image data; and a computer unit 75 converting the image data transmitted from the image pickup unit 73 into an image to be displayed on a monitor 74.

In the operation of the conventional all-directional monitoring system 70, a circular optical image obtained by the optical system unit 72 is converted into a circular image data. Subsequently, the image pickup unit 73 outputs the image data being image-converted to the computer unit 75. Then, the computer unit 75 processes the input image data to be an image which is more easily viewed by human, such as a rectangular panorama image, projected image or the like.

However, in the conventional all-directional monitoring system 70, the optical system uses a curved mirror designed to pick up a short-distance image. Therefore, when the all-directional monitoring system 70 is installed at an express highway or intersection to conduct monitoring of traffic conditions the image at a close range, the all-directional monitoring system 70 ensures the effect at a short-distance region but it has limitations in collecting an image at a long-distance region, for example, about 1 km or more in both directions on the road. Consequently, the all-directional monitoring system considerably decreases the capability of conducting monitoring over a long distance.

Moreover, since the curved mirror designed to pick up an image at 360 degrees in all directions is mounted onto the optical system of the all-directional monitoring system 70, when the all-directional monitoring system 70 is installed at an express highway or the like to conduct monitoring of the road, the image picked up by the curved mirror is distorted and it needs to be corrected to be a flat image. Then, when the distorted image is corrected to be the flat image, using a forward mapping method, mapping is not accurate by a correction coefficient and further points occur in a blank space. In this case, it needs a process of calculating values of the points in the blank space by interpolation and accordingly the quality of the image deteriorates after the distorted image is corrected.

### DISCLOSURE

### Technical Problem

Therefore, the present invention has been made to solve the above problems, and it is an aspect of the present invention to provide a camera secondary curved mirror structure, wherein the curved mirror structure mounted onto a camera is manufactured to minimize a short-distance region and to maximize a long-distance region, thereby maximizing collect-ability of a long-distance image in a multi-region monitoring system, and a CCTV multi-region monitoring system using the same, and a method for correcting a distorted image thereof.

It is another aspect of the present invention to provide a camera secondary curved mirror structure which is capable of collecting more images in the long-distance region compared to the short-distance region and clearly recognizing an object to be identified on the road, thereby efficiently considering traffic environments, and a CCTV multi-region monitoring system using the same, and a method for correcting a distorted image thereof.

It is another aspect of the present invention to provide a camera secondary curved mirror structure which clearly restores a curve image distorted by a curve mirror camera to the original image, thereby maximizing image restoration of a multi-region monitoring system, and a CCTV multi-region monitoring system using the same, and a method for correcting a distorted image thereof.

It is further another aspect of the present invention to provide a camera secondary curved mirror structure which clearly restores the image distorted by the curved mirror, without adding any complicated mechanical structures, thereby significantly improving price stability of a multi-region monitoring system, and a CCTV multi-region monitoring system using the same, and a method for correcting a distorted image thereof.

### Technical Solution

In accordance with an embodiment of the present invention, the above and other aspects can be accomplished by a camera secondary curved mirror structure, which is used in a camera device of a multi-region monitoring system for picking up a bidirectional image on the road and converting the image into an electrical image signal, comprising: a camera secondary curved mirror mounted onto the camera device, forwardly reflecting a bidirectional image being incident over a long distance on the road and collecting more long-distance images than short-distance images by its inside structure being partially removed and reconnected.

In accordance with another embodiment of the present invention, there is provided a method for manufacturing a camera secondary curved mirror, comprising: a process of removing a predetermined portion of a short-distance region and a process of completing a long-distance curved mirror. The process of removing a predetermined portion of a short-distance region comprises: removing a predetermined portion of a circular curved mirror for a camera of a multi-region monitoring system, to result in two curved mirror members, the predetermined portion established to be equidistant by a predetermined distance of m/R (wherein R is a radius of the circular curved mirror) from each side of a line which passes through the center-point of the circular curved mirror in a vertical direction; and jointing the two curved mirror members together, to form a joint line. The process of completing a long-distance curved mirror comprises: establishing a cutting line which is perpendicular to the joint line and which is at a predetermined distance n/D (wherein D is a diameter of the circular curved mirror) from a point where the joint line intersects the circumference of the jointed curved mirror members; and cutting along the cutting line so that a lower portion of the jointed curved mirror members results, forming the camera secondary curved mirror.

In accordance with another embodiment of the present invention, there is provided a CCTV multi-region monitoring system having a camera secondary curved mirror structure, comprising: a camera unit for picking up a long-distance image in all directions (360 degrees) of a road by a camera onto which a secondary curved mirror is mounted; an image signal processing unit for converting a long-distance distance image signal, which is obtained as a distorted optical image picked up by the camera unit, into an image data; and a computer unit for making a region of interest (ROI) by selecting an unwrapping region from the image data of the distorted image transmitted from the image signal processing unit, cropping a required curved region from the ROI and unwrapping the curved region to be converted into a flat image, and displaying the flat image on a monitor.

### ADVANTAGEOUS EFFECTS

In accordance with the present invention, a predetermine portion of a circular curved mirror positioned to be spaced apart from a camera lens or an internal camera circular curved mirror positioned to be spaced apart from a reflecting mirror by a predetermined distance is removed by a predetermined distance (m/R) (wherein R is a radius of the circular curved mirror) from each side of a line which passes through the center-point of the circular curved mirror in a vertical direction, to result in two curved mirror members; the two curved mirror members are jointed together to form a joint line; establishing a cutting line which is perpendicular to the joint line and which is at a predetermined distance n/D (wherein D is a diameter of the circular curved mirror after the predetermine portion of the short-distance region is removed) from a point where the joint line intersects the circumference of the jointed curved mirror members; and cutting along the cutting line so that a lower portion of the jointed curved mirror members results to be mounted as the camera curved mirror. Therefore, since the curved mirror structure mounted onto a front side of the camera lens is manufactured to minimize a short-distance region and to maximize a long-distance region, the collect-ability of a long-distance image in the multi-region monitoring system is maximized.

Furthermore, in accordance with the present invention, since more long-distance images than short-distance images are secured, an object to be identified on the road is clearly recognized and traffic environments are more efficiently acquired. Consequently, usability of the multi-region monitoring system is considerably improved.

Furthermore, in accordance with the present invention, a required region from a curved image being picked up is extracted as a fan-shape curved image, the extracted image is converted into a flat image by an unwrapping process, and the flat image is restored to the original image by a calibration process. Therefore, since one single CCTV camera is capable of monitoring all directions, at 360 degrees, it is capable of simultaneously observing up/down lines on the express highway.

Furthermore, in accordance with the present invention, a distorted image caused by a curved mirror is clearly restored, without any additional complicated mechanical structures. Therefore, price stability of the multi-region monitoring system is significantly improved.

### DESCRIPTION OF DRAWINGS

These and other aspects and advantages of the present invention will become apparent and more readily appreciated from the following description of the embodiments, taken in conjunction with the accompanying drawings, in which:

FIG. 1 is a view for explaining an example of a conventional multi-region monitoring system;

FIG. 2 is a view for explaining a camera curved mirror structure according to a first embodiment of the present invention;

FIG. 3 is a flow chart of the first embodiment of FIG. 2;

(a) through (c) of FIG. 4 are views for explaining a method for manufacturing the curved mirror according to the first embodiment;

FIG. 5 is a view for explaining an internal camera secondary curved mirror structure according to a second embodiment of the present invention;

FIG. 6 is a flow chart of the second embodiment of FIG. 5;

(a) through (d) of FIG. 7 are views for explaining a method for manufacturing the curved mirror according to the second embodiment;

FIG. 8 is a view for explaining a CCTV multi-region monitoring system according to a third embodiment of the present invention;

FIG. 9 is a flow chart of the third embodiment of FIG. 8;

(a) through (e) of FIG. 10 are views for explaining another example of the third embodiment of FIG. 8;

FIG. 11 is a graph for explaining a position of an image by a curved mirror in the third embodiment of FIG. 8;

FIG. 12 is a graph for explaining a flat position corresponding to a curved image in a method for correcting distortion in the third embodiment of FIG. 8;

FIG. 13 is a view for explaining an example of loading a calibration grid in the method for correcting distortion in the third embodiment of FIG. 8; and

FIG. 14 is a view for explaining an example of a calibration process in the method for correcting distortion in the third embodiment of FIG. 8.

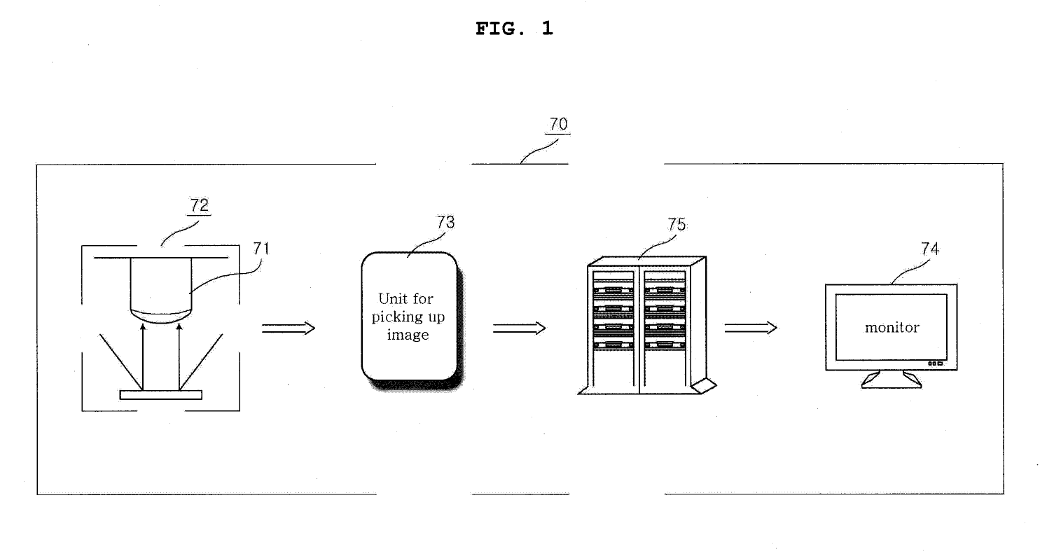

### BEST MODE

Hereinafter, embodiments of the present invention will be described in detail with reference to the accompanying drawings. This invention may, however, be embodied in many different forms and should not be construed as being limited to the embodiments set forth herein.

### Embodiment 1

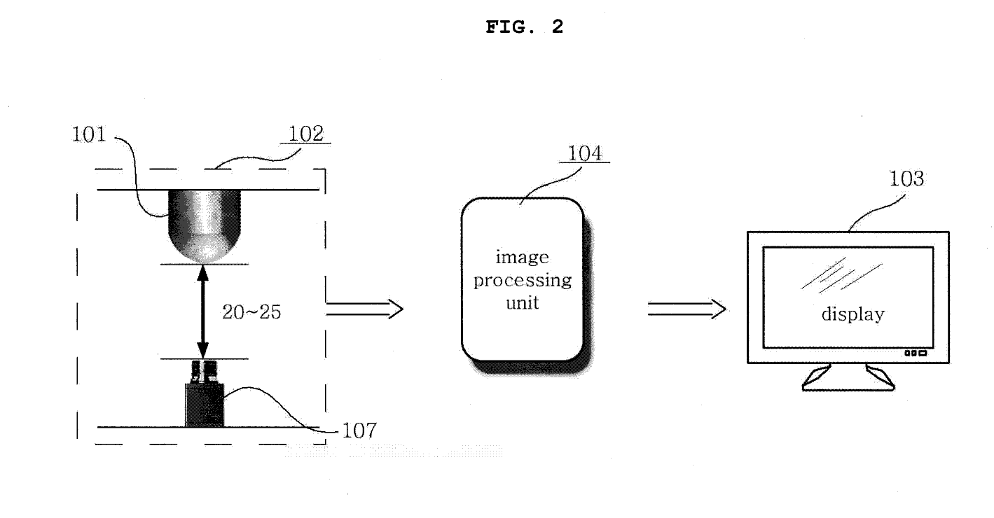

As illustrated in FIG. 2, a camera curved mirror structure according to a first embodiment of the present invention comprises: a camera secondary curved mirror 101, a camera unit 102, and an image processing unit 104.

The camera secondary curved mirror 101 forwardly reflects a bidirectional image being incident over a long distance, for example, 2 km or more, on the road. Since the inside curved mirror structure is partially removed and reconnected, the camera secondary curved mirror 101 collects more long-distance images than short-distance images.

The camera unit 102 picks up the bidirectional image being incident over a long distance, for example, 2 km or more, on the road and being reflected by the camera curved mirror 101. The camera unit 102 also converts the image into an electrical image signal.

The image processing unit 104 performs an image signal process of the bidirectional image over a long distance, which is picked up by the camera unit 102. The image processing unit 104 also corrects distortion of the image signal to be unwrapped, to be displayed on a display 103.

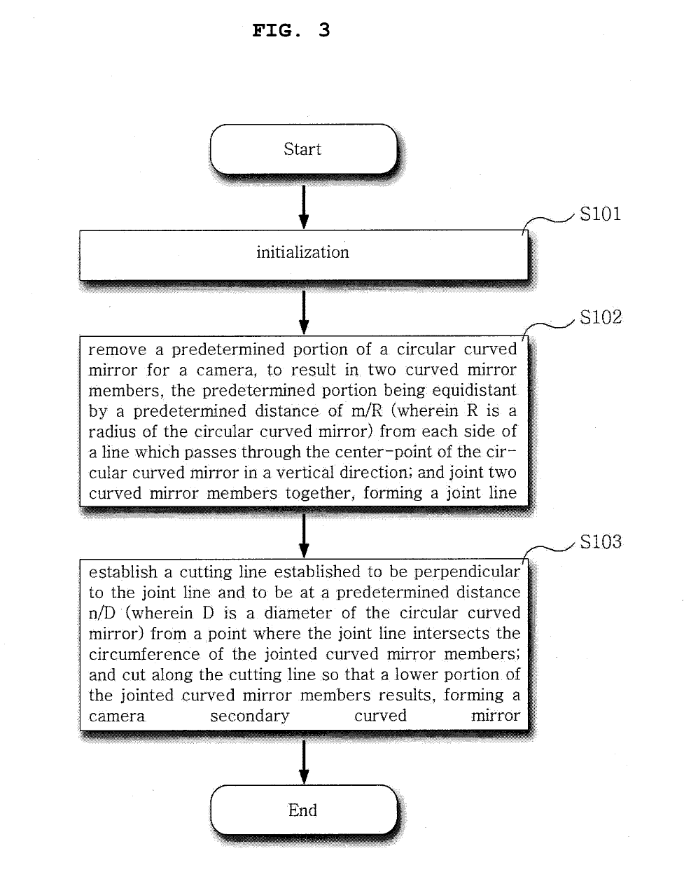

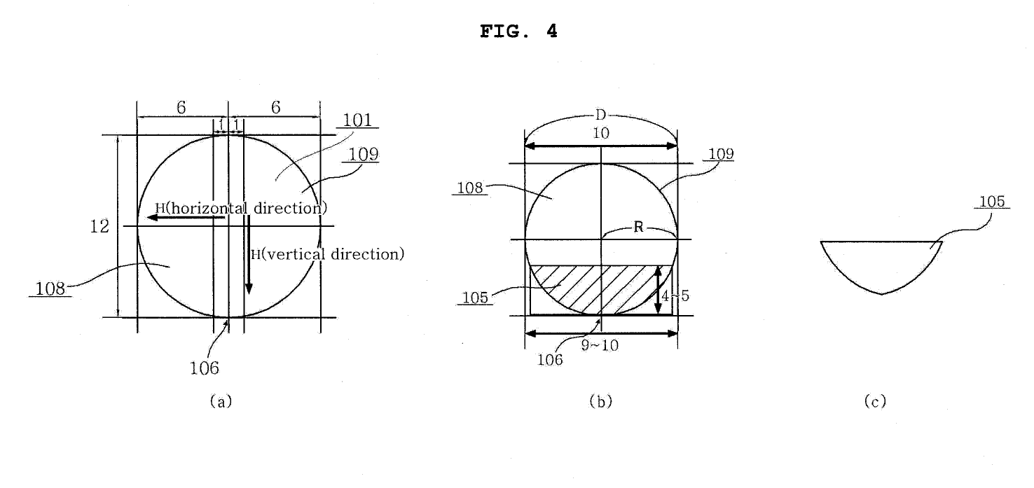

A method for manufacturing the camera secondary curved mirror according to the first embodiment of the present invention will be described. As illustrated in FIG. 3, an initial state in step S101 goes to a process of removing a predetermined portion of a short-distance region in step S102. Step S102 removes a predetermined portion of a camera circular curved mirror which is equidistant, by a predetermined distance of m/R (wherein R is a radius of the circular curved mirror), from each side of a line which passes through the center-point of the circular curved mirror in a vertical direction, so that the predetermine portion of the short-distance region is removed. After the predetermined portion is removed to result in curved mirror members, the mirror members are jointed together to form a joint line.

The process of removing the predetermine portion of the short-distance region, step S102, is followed by another process to complete a long-distance curved mirror, step S103. That is, step S102 removes the predetermine portion of the short-distance region and joints the mirror members together. Step S103 establishes a cutting line which is perpendicular to the joint line and which is at a predetermined distance n/D (wherein D is a diameter of the curved mirror after the predetermine portion of the short-distance region is removed) from a point where the joint line intersects the circumference of the curved mirror members and cuts along the cutting line so that a lower portion of the jointed curved mirror members results, forming the camera secondary curved mirror.

For example, the method for manufacturing the camera secondary curved mirror will be described with reference to (a) through (c) of FIG. 4.

As illustrated in (a) of FIG. 4, a predetermined portion of the short-distance region is removed from a circular curved mirror for a camera 107. The predetermined portion is equidistant by a predetermined distance m/R (wherein R is a radius of the circular curved mirror) from each side of a line which passes through the center-point of the circular curved mirror in a vertical direction. For example, when a ratio of a radius of a circular mirror is 10, a predetermined portion of the short-distance region is removed by 2/10 from each side of a line which passes through the center-point of the circular mirror in a vertical direction, resulting in curved mirror members 108 and 109. Subsequently, the mirror members 108 and 109 are jointed together to form a joint line.

As illustrated in (b) of FIG. 4, a cutting line (in a H-direction) is established to be perpendicular to the joint line (in a V-direction) and to be at a predetermined distance n/D (wherein D is a diameter of the curved mirror after the predetermine portion of the short-distance region is removed) from a point 106 where the joint line intersects the circumference of the curved mirror members 108 and 109. Then, the curved mirror is cut along the cutting line, resulting a lower portion of the jointed curve mirror members 108 and 109. For example, when a ratio of the diameter of the circular mirror is 12, the curved mirror is by the predetermined portion based on 4/12 (n/D) so that the lower portion of the curved mirror members results, forming the camera secondary curved mirror 101.

As illustrated in (c) of FIG. 4, the camera secondary curved mirror 101 is installed to be spaced apart from a camera lens of the camera unit 102 by a predetermined distance, for example, about 20 to 25 cm. The camera secondary curved mirror 101 is controlled depending on a focus distance of the camera 107.

When the camera secondary curved mirror 101 is mounted onto the camera unit 102 and is operated, it reflects the bidirectional image over a distance of 2 km or more, forwardly to the camera lens of the camera unit 102 positioned to be spaced apart from each other by the predetermined distance.

Then, the camera unit 102 picks up the bidirectional image over a long distance, for example, 2 km or more, on the road, which is reflected by the camera secondary curved mirror 101. Further, the camera unit 102 converts the bidirectional image into an electrical image signal to be output to the image processing unit 104.

Subsequently, the image processing unit 104 performs the image signal process of the bidirectional image signal over a long distance picked up by the camera unit 102. For example, the image processing unit 104 corrects the distortion of the image signal to be unwrapped, so as to be displayed on a display.

### Embodiment 2

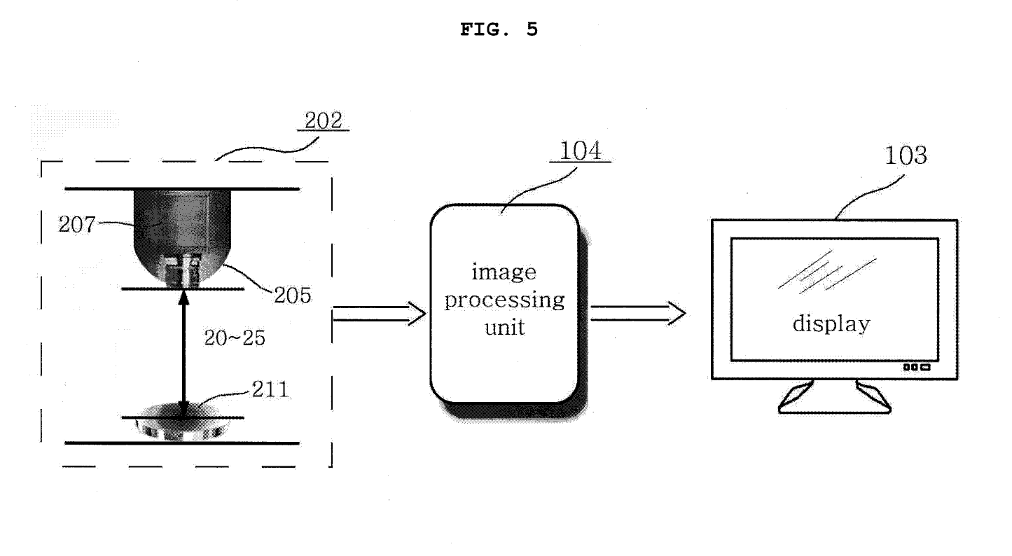

As illustrated in FIG. 5, an internal camera secondary curved mirror structure according to a second embodiment of the present invention comprises: an internal camera secondary curved mirror 205, a camera unit 202, and an image processing unit 204.

The internal camera secondary curved mirror 205 collects a bidirectional image over a long distance, for example, 2 km or more, on the road. Since the inside curved mirror structure is partially removed and reconnected, the internal camera secondary curved mirror 205 collects more long-distance images than short-distance images. A camera 207 is included in the internal camera secondary curved mirror 205.

The camera unit 202 picks up the bidirectional image over a long distance, for example, 2 km or more, on the road, which is reflected by the internal camera curved mirror 205. The camera unit 202 converts the image into an electrical image signal.

The image processing unit 204 performs an image signal process of the bidirectional image over a long distance, which is picked up by the camera unit 202. The image processing unit 204 corrects distortion of the image signal to be unwrapped, so as to be display on a display 203.

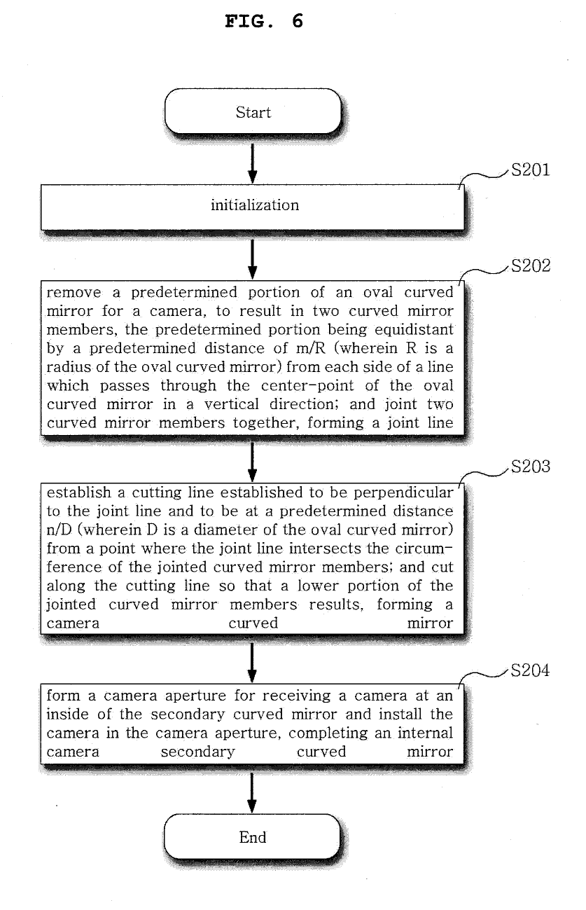

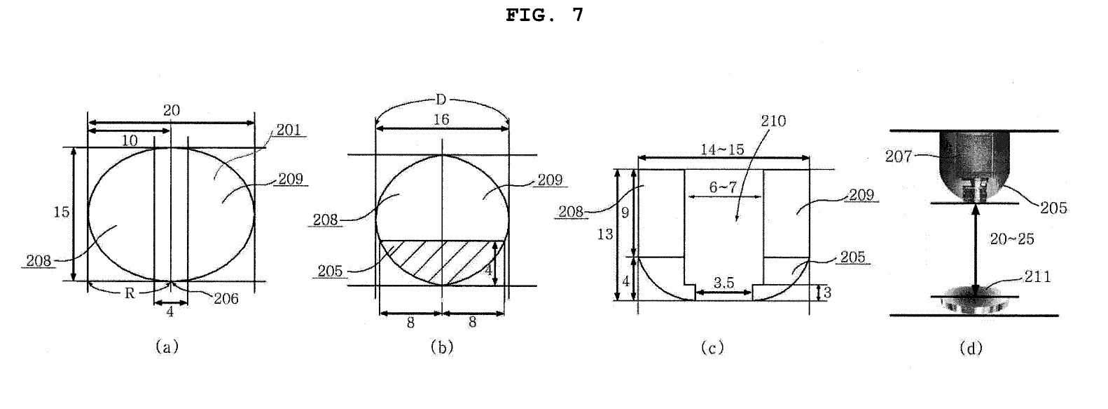

A method for manufacturing the internal camera secondary curved mirror according to the second embodiment of the present invention will be described. As illustrated in FIG. 6, an initial state in step S201 goes to a process of removing a predetermined portion of a short-distance region in step S202. Step S202 removes a predetermined portion of a camera oval curved mirror which is equidistant, by a predetermined distance of m/R (wherein R is a radius of the curved mirror), from each side of a line which passes through the center-point of the oval curved mirror in a vertical direction, so that the predetermine portion of the short-distance region is removed. After the predetermined portion is removed to result in curved mirror members, the mirror members are jointed together to form a joint line.

The process of removing the predetermine portion of the short-distance region, step S202, is followed by another process to complete a long-distance curved mirror, step S203. That is, step S202 removes the predetermine portion of the short-distance region and joints the mirror members together. Step S203 establishes a cutting line which is perpendicular to the joint line and which is at a predetermined distance n/D (wherein D is a diameter of the curved mirror after the predetermine portion of the short-distance region is removed) from a point where the joint line intersects the circumference of the curved mirror members and cuts along the cutting line so that a lower portion of the jointed curved mirror members results, forming the internal camera secondary curved mirror.

Subsequently, going to step S204, a process of forming a camera aperture is performed. That is, step S204 forms a camera aperture for building a camera in the inside of the internal camera secondary curved mirror completed in step S203 and installs the camera in the camera aperture. Accordingly, the internal camera secondary curved mirror is completed.

For example, the method for manufacturing the internal camera secondary curved mirror will be described with reference to FIGS. 7A, 7B, 7C and 7D.

As illustrated in FIG. 7A, a predetermined portion of the short-distance region is removed from an oval curved mirror 201 for a camera 207. The predetermined portion is equidistant by a predetermined distance m/R (wherein R is a radius of the oval curved mirror) from each side of a line which passes through the center-point of the oval curved mirror in a vertical direction. For example, when a ratio of a radius of an oval mirror is 10 in a horizontal direction, a predetermined portion of the short-distance region is removed by 2/10 (m/R) from each side of a line which passes through the center-point of the oval mirror in a vertical direction, resulting in curved mirror members 208 and 209. Subsequently, the mirror members 208 and 209 are jointed together to form a joint line.

Subsequently, as illustrated in FIG. 7B, a cutting line (in a H-direction) is established to be perpendicular to the joint line (in a V-direction) and to be at a predetermined distance n/D (wherein D is a diameter of the curved mirror after the predetermine portion of the short-distance region is removed) from a point 206 where the joint line intersects the circumference of the curved mirror members 208 and 209. Then, the curved mirror is cut, along the cutting line so that a lower portion 206 of the jointed curved mirror members 208 and 209 results. For example, in (b) of FIG. 7, the curved mirror is cut by the predetermined portion based on 4/13 (n/D) so that the lower portion 206 of the jointed curved mirror members 208 and 209 results, forming the internal camera secondary curved mirror 205.

As illustrated in. FIG. 7C, a camera aperture in a predetermined shape is formed at the center in the internal camera secondary curved mirror 205. For example, a camera aperture 210 is formed in the same shape as that of the internal camera 207, which is 6 to 7 cm in width and is 3.5 cm in lower end thickness.

As illustrated in (c) of FIG. 7, the camera 207 is installed in the camera aperture 210 formed in the internal camera secondary curved mirror 205 to be completed.

The internal camera secondary curved mirror 205 completed through the above processes is installed to be spaced apart from a reflecting mirror 211 of the camera unit 202 by a predetermined distance, for example, about 20 to 25 cm. The internal camera secondary curved mirror 205 is controlled depending on a focus distance of the camera.

When the internal camera secondary curved mirror 205 is mounted onto the camera unit 202 and is operated, the camera 207 built in the internal camera secondary curved mirror 205 picks up the bidirectional image being incident over a long distance, for example, 2 km or more, which is reflected by the reflecting mirror 211. Further, the camera 207 transmits the bidirectional image over a long distance to an inside circuit of the camera unit 202.

Then, the bidirectional image over a long distance may be reflected by the reflecting mirror 211 and then may be incident on the camera 207. Otherwise, after the bidirectional image over a long distance is incident on the internal camera secondary curved mirror 205, the internal camera secondary curved mirror 205 may reflect the bidirectional image to the reflecting mirror 211 positioned in front of the internal camera secondary curved mirror 205, to be incident on the camera 207.

Then, the camera unit 202 picks up the bidirectional image over a long distance, for example, 2 km or more, on the road, which is collected by the internal camera secondary curved mirror 205. Further the camera unit 202 converts the bidirectional image into an electrical image signal to be output to the image processing unit 204. Subsequently, the image processing unit 204 performs the image signal process of the long-distance bidirectional image signal picked up by the camera unit 202. For example, the image processing unit 204 corrects the distortion of the image signal to be unwrapped to be displayed on a display.

### Embodiment 3

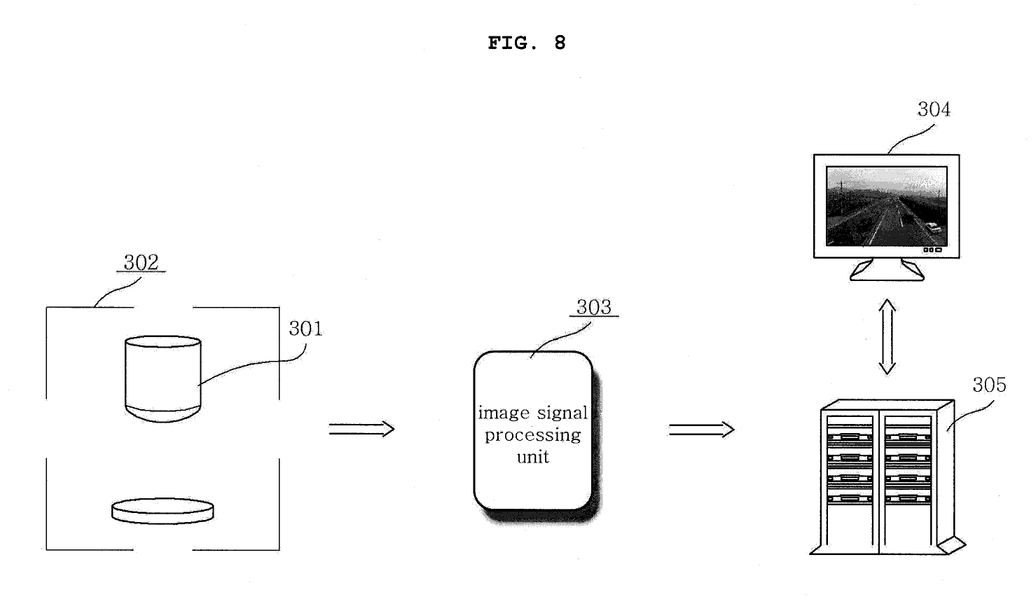

As illustrated in FIG. 8, a CCTV multi-region monitoring system having a camera secondary curved mirror structure according to a third embodiment of the present invention comprises: a camera unit 302, an image processing unit 303 and a computer unit 305.

The camera unit 302 picks up conditions of an image over a long distance of the road, for example, the all-directional (360 degrees) conditions at a distance of 2 km or more on the express highway, through a camera 301 onto which a secondary curved mirror.

The image processing unit 303 converts a long-distance image signal of a distorted optical image picked up by the camera unit 302 into an image data.

The computer unit 305 makes a region of interest (ROI) by selecting an unwrapping region from the image data of the distorted image, crops a required curved region from the ROI, for example, in a fan shape, unwraps the fan-shape curved region to be converted into a flat image, and displays the unwrapped image on a monitor 304.

The computer unit 305 further restores a rough flat image to the original image through an image calibration process. When a flat image distorted in bilateral symmetry is output since a camera of the camera unit 302 is positioned at a lower part of the secondary curved mirror, the computer unit 305 further corrects the distorted flat image.

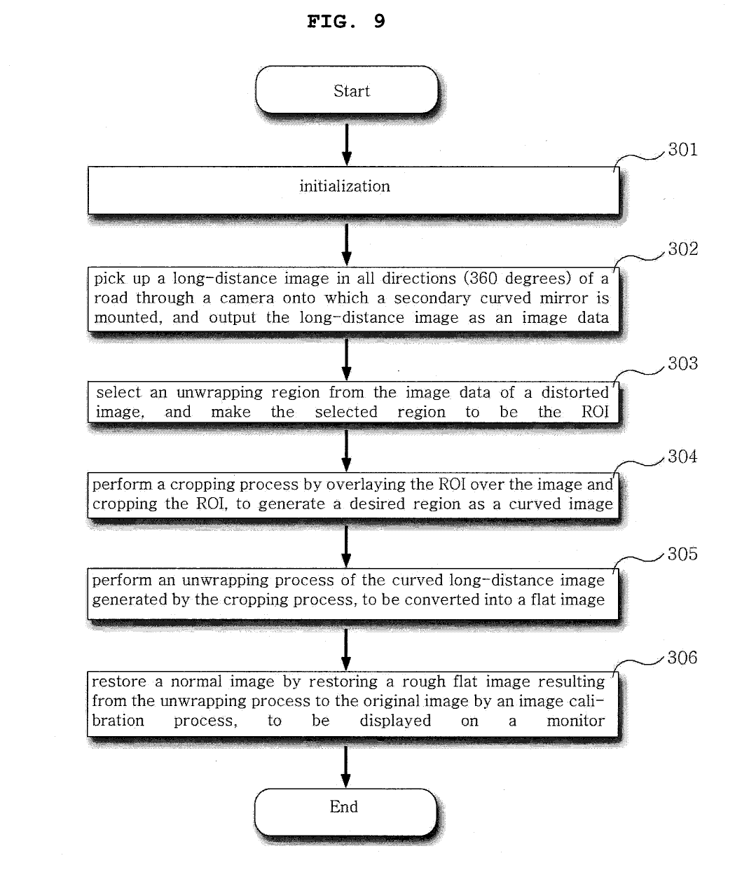

A method for controlling the CCTV multi-region monitoring system according to the third embodiment will be described. As illustrated in FIG. 9, an initial state in step S301 goes to a process of picking up an image in step S302. In step S302, a camera onto which a secondary curved mirror is mounted picks up a long-distance image in all directions (360 degrees) on the road and outputs the long-distance image to be an image data.

In step S303, a process of establishing a ROI is performed by selecting an unwrapping region from the image data of the distorted image and making the selected region to be the ROI.

In step S304, a cropping process is performed. In this step, after the ROI is overlaid on the image, the cropping process of the ROI is performed to generate a desired region as an image in a curved shape (a fan-shape).

In step S305, an unwrapping process is performed. The long-distance image which is curved by the cropping process is unwrapped to be converted a flat image.

In step S306, a process of restoring a normal image is performed. A rough flat image resulting from the unwrapping process is restored to the original image through an image calibration process, to be displayed on a monitor.

In step S306, a process of restoring an original image is further performed. That is, when a flat image distorted in bilateral symmetry is output since the camera of the camera unit is positioned at a lower part of the secondary curved mirror, step S306 further restores the distorted flat image to the original image by correcting the distorted flat image.

The process of restoring the normal image, step S306, comprises: a grid load step, a grid set step, a flat image load step, and a calibration step.

The grid load step is to load various calibration grids.

The grid set step is to set a grid required for restoring a flat image, for example, a nonlinear grid, among the various calibration grids being loaded.

The flat image load step is to load an unwrapped rough flat image for calibration.

The calibration step is to calibrate a flat image by composing the loaded rough flat image and the set grid, that is, the nonlinear grid, to result in a clear flat image.

For example, as illustrated in (a) of FIG. 10, a camera unit 2 picks up a long-distance image of a road, for example, the road conditions at a distance of 2 km or more in all directions (360 degrees) of an express highway, through a camera 301 onto which a secondary curved mirror is mounted, and transmits the long-distance image to an image processing unit 303. The image processing unit 303 converts a long-distance image signal of a distorted optical image picked up by the camera unit 302 into an image data, to be transmitted to a computer unit 305.

As illustrated in (b) and (c) of FIG. 10, the computer unit 305 makes a ROI by selecting an unwrapping region from the image data of the distorted image transmitted from the image processing unit 303. As illustrated in (d) of FIG. 10, the computer unit 305 generates a desired region as an image in a specific curved shape, for example, a fan-shape curved image, through a cropping process. As illustrated in FIG. E, the computer unit 305 further converts the fan-shaped curved image which results from the cropping process, into a flat image through an unwrapping process.

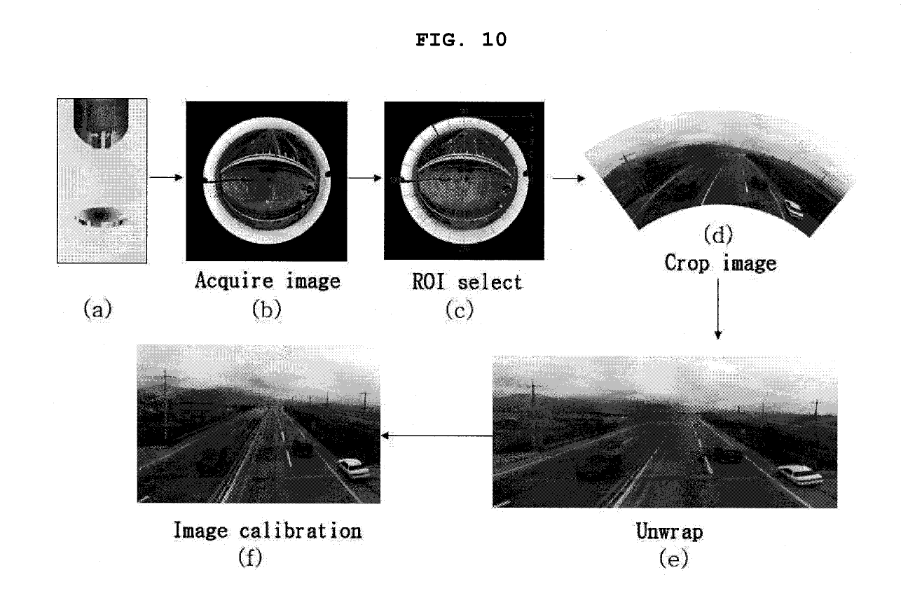

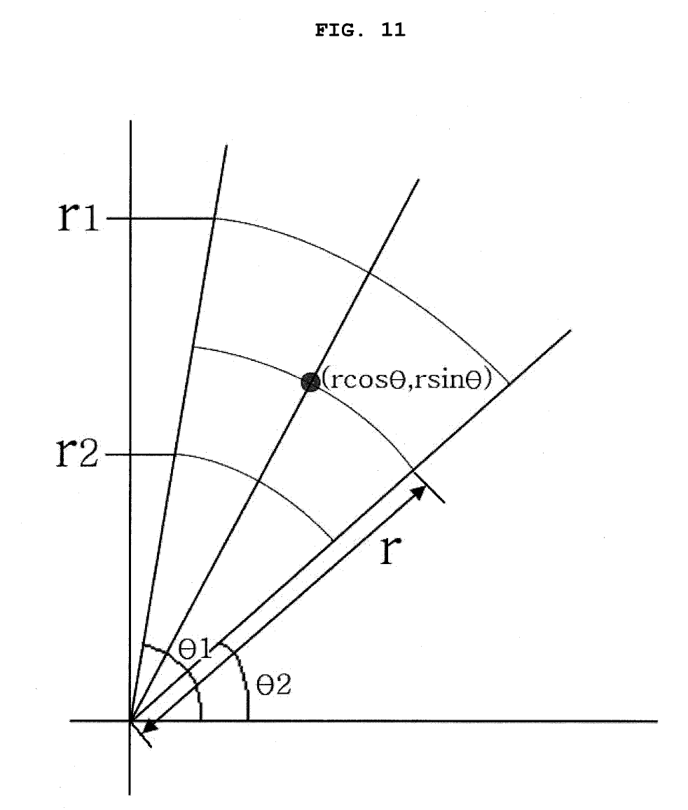

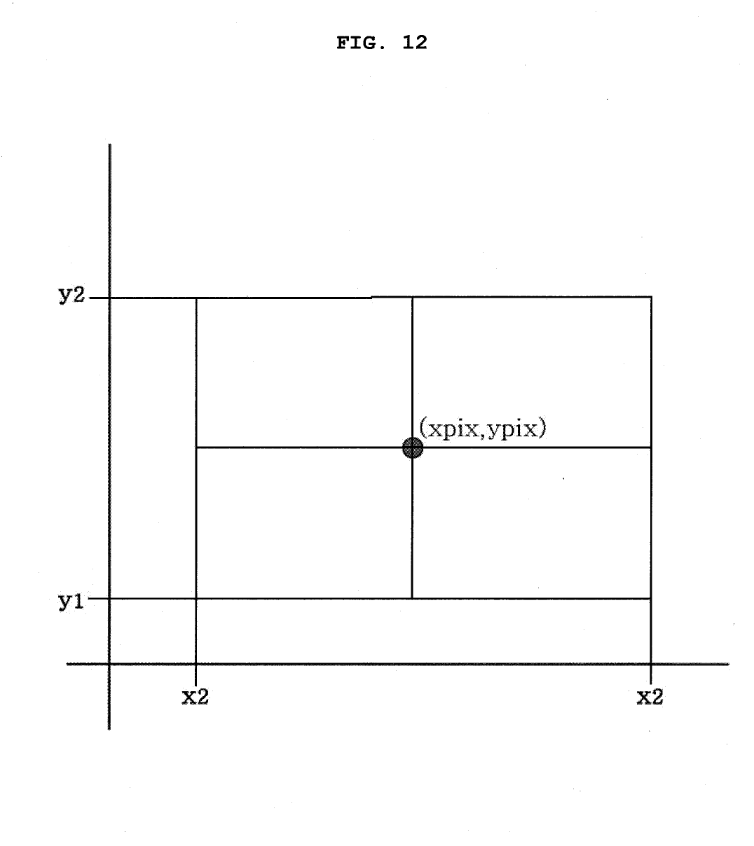

When the computer unit 305 performs the unwrapping process of the curved image of the desired region, the relation between the positions of r1 and r2 of the curved image illustrated in FIG. 11 and the position of y1 and y2 of the flat image illustrated in FIG. 12 is written as follows:

$$\frac{r 1}{r 2} = \frac{y 1}{y 2} \qquad [ Formula 1 ]$$

The relation between θ1 and θ2 of the curved image illustrated in FIG. 11 and x1 of the flat image illustrated in FIG. 12 is written as follows:

$$\frac{θ 1}{θ 2} = \frac{x 1}{x 2} \qquad [ Formula 2 ]$$

Therefore, a method for shifting a point (rcos θ, rsin θ) on the curved mirror to a point (xpix, ypix) on the plane is as follows:

When it is assumed that a variable pxpix varies to increase by 1 from x1 to x2, the displacement can be expressed as follows:

$$θ 1 + ( \frac{pxpix - x 1}{x 2 - x 1} ) ( θ 2 - θ 1 ) \qquad [ Formula 3 ]$$

In Formula 3, when a pypix varies to increase by 1 from y1 to y2, depending on a value of the variable pxpix, a radius r depending on a value of the pypix is written as follows:

$$r = r 1 + ( \frac{pypix - y 1}{y 2 - y 1} ) ( r 2 - r 1 ) \qquad [ Formula 4 ]$$

In conclusion, a value of the point (xpix, ypix) on the plane is determined by Formula 5 and Formula 6.

xpix=r*cos θ [Formula 5]

Ypix=r*sin θ [Formula 6]

Therefore, the computer unit 305 crops and unwraps the ROI by using Formula 5 and Formula 6, converts the ROI into the flat image and displays the flat image on the monitor 304.

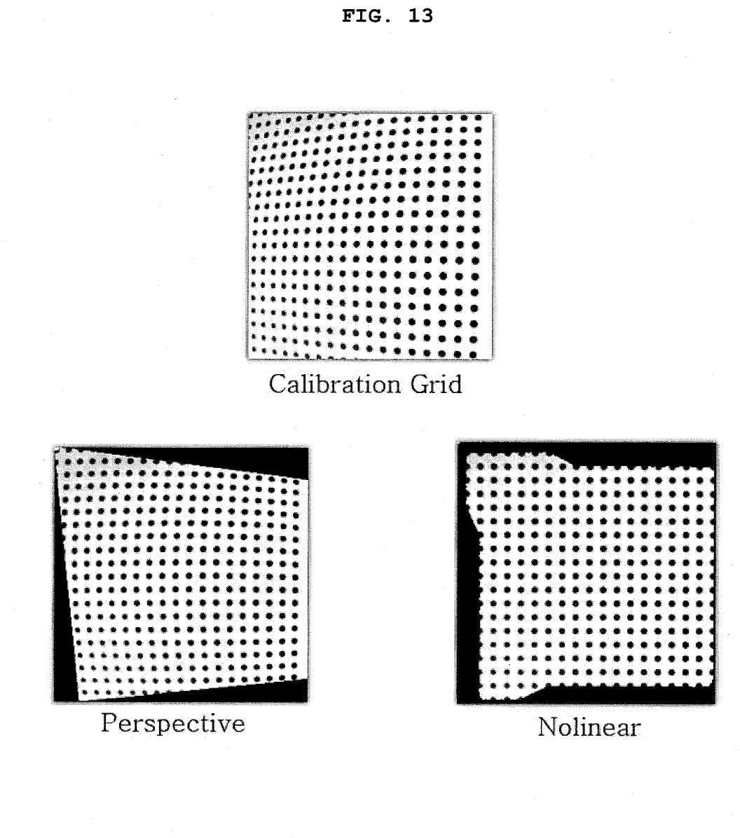

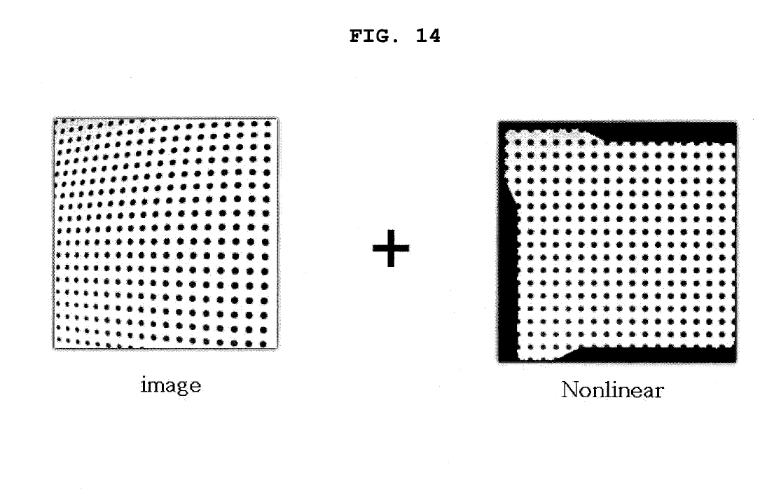

As illustrated in FIG. 13, the computer unit 305 loads various calibration grids and sets a desired calibration grid among the loaded calibration grids, for example, a nonlinear grid. As illustrated in FIG. 14, the computer unit 306 calibrates a flat image by composing a rough flat image and the set grid, that is, the nonlinear grid, and calculates a clear flat image to be restored to the original image. Then, when a flat image distorted in bilateral symmetry is output since the camera of the camera unit 302 is positioned at a lower part of the secondary curved mirror, the computer unit 305 corrects the distorted flat image and displays the corrected flat image on the monitor 304.

### INDUSTRIAL APPLICABILITY

As described above, in accordance with the present invention, since the curved mirror structure is manufactured to minimize the short-distance region and to maximize the long-distance region, it secures more long-distance images than short-distance images. Therefore, an object to be identified on the road is clearly recognized and traffic environments are more efficiently perceived. Furthermore, in accordance with the present invention, the required region from the curved image being picked up is extracted as the curved image in the fan-shape, the extracted image is converted into the flat image through the unwrapping process, and the flat image is restored to the original image by the calibration process. Therefore, a single CCTV camera using the secondary curved mirror is capable of monitoring all directions at 360 degrees and observing the up/down lines of the express highway. Consequently, when the CCTV is installed on the highway, it is very usably applied.

1. A camera secondary curved mirror structure in a camera unit for a multi-region monitoring system picking up a bidirectional image of a road and converting the bidirectional image into an electrical image signal, comprising:
a camera secondary curved mirror mounted on the camera unit to forwardly reflect an incident bidirectional image over a long distance of the road and to collect more long-distance images than short-distance images by its inside curved mirror structure being partially removed and reconnected.

2. A method for manufacturing a camera secondary curved mirror, comprising:
a step of removing a predetermined portion of a short-distance region portion being equidistant by a predetermined distance of m/R (wherein R is a radius of the circular curved mirror) from each side of a line which passes through the center-point of the circular curved mirror in a vertical direction, and
by jointing the two curved mirror members together to form a joint line; and
a step of completing a long-distance curved mirror
by establishing a cutting line which is perpendicular to the joint line and which is at a predetermined distance n/D (wherein D is a diameter of the circular curved mirror after the predetermine portion of the short-distance region is removed) from a point where the joint line intersects the circumference of the jointed curved mirror members, and
by cutting along the cutting line so that a lower portion of the jointed curved mirror members results, to form the camera secondary curved mirror.

3. The method according to claim 2, the method further comprising a step of forming a camera aperture for receiving a camera at an inside of the secondary curved mirror and installing the camera in the camera aperture, to complete the internal camera secondary curved mirror.

4. The method according to claim 2, wherein, in the step of removing the predetermine portion of the short-distance region, when the predetermined distance is m/R, m is 1 and R is 6.

5. The method according to claim 2, wherein, in the step of completing the long-distance curved mirror, when the predetermined distance is n/D, n is 4 and D is 12.

6. The method according to claim 2, wherein, in the step of removing the predetermine portion of the short-distance region, when the predetermined distance is m/R, m is 2 and R is 10.

7. The method according to claim 5, wherein, in the step of completing the long-distance curved mirror, when the predetermined distance is n/D, n is 4 and D is 13.

8. A CCTV multi-region monitoring system having a camera secondary curved mirror structure, comprising:
a camera unit for picking up a long-distance image in all directions (360 degrees) of a road, through a camera onto which a secondary curved mirror is mounted;
an image signal processing unit for converting a long-distance image signal of a distorted optical image, which is picked up by the camera unit, into an image data; and
a computer unit for making a region of interest (ROI) by selecting an unwrapping region from the image data of the distorted image transmitted from the image signal processing unit, cropping a required curved region among the ROI, unwrapping the cropped curved region, converting the unwrapped curved image into a flat image, and displaying the flat image on a monitor.

9. The system according to claim 8, wherein the curved region set by the cropping is fan-shaped.

10. The system according to claim 8, wherein the computer unit further has a function of restoring a rough flat image to the original image, by an image calibration process.

11. The system according to claim 8, wherein, when a flat image distorted in bilateral symmetry is output by the camera of the camera unit positioned at a lower part of the secondary curved mirror, the computer unit further has a function of correcting the distorted flat image to be restored to the original image.

12. A method for correcting a distorted image in a CCTV multi-region monitoring system having a camera secondary curved mirror structure, comprising:
a step of picking up a long-distance image in all directions (360 degrees) of a road through a camera onto which a secondary curved mirror is mounted and outputting the long-distance image as an image data;
a step of setting a ROI by selecting an unwrapping region from the image data of a distorted image and making the selected region to be the ROI;
a step of performing a cropping process by overlaying the ROI over the image and cropping the ROI to generate a desired region as a curved image in a specific shape;
a step of performing an unwrapping process of the curved image of the long-distance road by the cropping process, to be converted into a flat image; and
a step of restoring a normal image by restoring a rough flat image resulting from the unwrapping process to the original image by an image calibration process, to be displayed on a monitor.

13. The method according to claim 12, wherein the curved image in a specific shape generated through the cropping process is fan-shaped.

14. The system according to claim 12, wherein the step of restoring the normal image further comprises:
a grid load step of loading various calibration grids;
a grid set step of setting a grid required for restoring the flat image, for example, a nonlinear grid, among the loaded various calibration grids;
a flat image load step of loading the unwrapped rough flat image to be calibrated; and
a calibration step of calibrating the flat image by composing the loaded rough flat image and the set grid, that is, the nonlinear grid, to output a clear flat image.

15. A method for correcting a distorted image in a CCTV multi-region monitoring a camera secondary curved mirror structure, comprising:
a step of picking up a long-distance image in all directions (360 degrees) of a road through a camera onto which a secondary curved mirror is mounted and outputting the long-distance image as an image data;
a step of making a ROI by selecting an unwrapping region from the image data of a distorted image and making the selected region to be the ROI;
a step of performing a cropping process by overlaying the ROI over the image and cropping the ROI to generate a desired region as a curved image in a specific shape;
a step of performing an unwrapping process of the curved image of the long-distance road by the cropping process, to be converted into a flat image; and
a step of restoring a normal image by restoring a rough flat image resulting from the unwrapping process to the original image by an image calibration process, and thereafter, when a flat image distorted in bilateral symmetry is output by the camera of the camera unit positioned at a lower part of the secondary curved mirror, correcting the distorted flat image to be restored to the original image, to be displayed on a monitor
